(19) United States
(12) Patent Application Publication
(10) Pub. No.: US 2019/0193358 A1
(43) Pub. Date: Jun. 27, 2019

(54) HYBRID MOLD FOR SHOE SOLE

(71) Applicant: Compagnie Generale des Etablissements Michelin, Clermont-Ferrand (FR)

(72) Inventor: PHILIPPE SOUYRI, Clermont-Ferrand (FR)

(21) Appl. No.: 16/232,605

(22) Filed: Dec. 26, 2018

(30) Foreign Application Priority Data
Dec. 27, 2017 (FR) 1771435

(51) Int. Cl. B29D 35/00; A43B 13/04; A43B 13/14; B29C 33/38; B33Y 80/00

(52) U.S. Cl. CPC B29D 35/0063; A43B 13/04; B29K 2905/00; B29C 33/3842; B33Y 80/00; A43B 13/14

(57) ABSTRACT

A hybrid mold (1) for a shoe sole comprises a body (7) affording a molding surface (3) and at least one molding insert (2), the molding insert (2) being produced according to a first method and the molding surface (3) being produced according to a second method distinct from the first.

### TECHNICAL FIELD OF THE INVENTION

The present invention relates to a hybrid mould for a shoe sole.

### PRIOR ART

Over the past few years, shoe soles of increasingly varied shape and colour have been appearing on the market. Certain highly original shapes are intended purely to produce an attractive visual effect or an effect that adds value to the product. Other shapes are intended to produce one or more technical effects, such as, for example, a shock-absorbing effect, a comfort effect, a grip effect, a protective effect, etc.

Continuing in this vein towards wide diversity and originality, sole manufacturers have recently incorporated certain new manufacturing methods allowing even more unconventional products to be produced.

For example, document KR20140146737 describes a method for manufacturing a made-to-measure shoe sole, comprising a step of obtaining 3D data of the insole by means of a photograph of a client's sole, with a 3D measurement means, a step of modifying the 3D data of the sole to form the data for the made-to-measure shoe sole, a step of completing the made-to-measure sole by transmitting the data to the 3D printer.

This solution is relatively cumbersome and expensive to implement and is of benefit only for specific products produced as one-offs or in very small quantities.

Document CN204426864 describes a method for manufacturing sports shoes easy to assemble and to separate. The various soles are created using a 3D printer.

Document CN104959597 describes a method for manufacturing shoe soles using a 3D printer.

These various examples using 3D printing use expensive solutions with very low productivity, so that soles cannot be produced under advantageous conditions on a large scale.

Document US20070063368 describes a shoe mould made up of several parts, including a part made as a solid metallic structure, and another part produced as a cellular metallic structure intended to facilitate ventilation during moulding. The cellular part is produced by moulding using particles of foam. This type of mould is relatively complex and expensive yet for all that does not make it possible to produce complex shapes in the moulded sole.

There is therefore a need to create and produce shoe soles that are original, but at costs that are attractive for high-volume production runs.

### SUMMARY OF THE INVENTION

First of all, a first object of the invention is to provide a means to make it possible to create and manufacture soles of original and innovative shapes, for an attractive cost.

Another object of the invention is to provide a means making it possible to create and manufacture soles provided with novel shapes or patterns.

Yet another object of the invention is to provide a mould element that offers a great deal of flexibility in the layout of textures.

Another object of the invention is to provide a mould element provided with very fine and/or complex textures produced in an optimal way.

In order to achieve this, the invention provides a hybrid mould for a shoe sole, the said mould comprising a body affording a moulding surface and at least one moulding insert, the moulding insert being produced according to a first method and the moulding surface being produced according to a second method distinct from the first, the moulding insert being produced using a method of manufacture by addition of material, preferably metallic material.

Such a design of mould element makes it possible to optimize the manufacture of the inserts used to support the textures so that in this way very fine and/or complex textures can be produced using a manufacturing method specifically suited to this requirement. This design allows a near infinite number of textures to be arranged on a main body that is simple and inexpensive to produce. The method of manufacture through the addition of metallic material is, for example, a method involving selective laser melting.

The features of the textures are adapted to suit the soles that are to be produced.

According to one exemplary embodiment, the moulding surface is produced according to a method not involving the addition of material.

This method of manufacture is particularly well suited to the shaping of texture elements of very small dimensions and/or complex shapes. The main body is advantageously achieved by a conventional method, such as, for example, by pressing. This method of manufacture is simple to implement and allows components of small thickness to be produced with a high level of reliability, at a particularly advantageous cost. Each of the components of the assembly is thus optimized, both from the viewpoint of cost and in terms of the requisite mechanical properties.

According to one advantageous embodiment, the insert comprises a plurality of textures. The characteristics of the textures are adapted to suit the soles that are to be produced.

According to one exemplary embodiment, the textures of the insert are obtained by laser etching.

In one exemplary embodiment, the textures of the insert comprise a plurality of recessed or protruding elements formed as one with the said insert.

According to one advantageous embodiment, securing means for securing the first zone to the main body of the mould are produced by bonding or welding or clipping or screwing or clamping.

According to another advantageous embodiment, the insert comprises a plurality of complex moulding shapes for sole treads.

Numerous alternative forms of embodiment of these complex shapes are possible. For example, at least one complex moulding shape comprises a main plane that is not parallelepipedal. According to another example, at least one complex moulding shape comprises a main plane that has a bulging zone. According to yet another example, at least one complex moulding shape comprises a main plane in the shape of an elongated Y or S. Yet another example is one whereby at least one complex moulding shape comprises a main plane and a plurality of secondary planes which are substantially perpendicular.

### DESCRIPTION OF THE FIGURES

All the embodiment details are given in the description which follows, which is supplemented by FIGS. 1 to 16 give solely by way of nonlimiting examples and in which:

FIGS. 1A and 1B are views in cross section of examples of hybrid moulds according to the invention;

FIGS. 2 and 3 are examples of shoe soles manufactured by means of a hybrid mould according to the invention;

FIGS. 4a to 16 illustrate examples of moulding shapes for complex sole treads.

### DETAILED DESCRIPTION OF THE INVENTION

What is meant by “texture” is an organized arrangement of a plurality of elements (stripes, holes, strands, blades) all or some of these elements being repeats of the one same basic element, the pattern present on the mould making it possible to obtain a particular texture on a sole.

What is meant by “complex moulding shape for a sole tread” is a shape that can be achieved by selective laser melting, that allows the moulding of a sole tread pattern profile the shape of which is nonplanar.

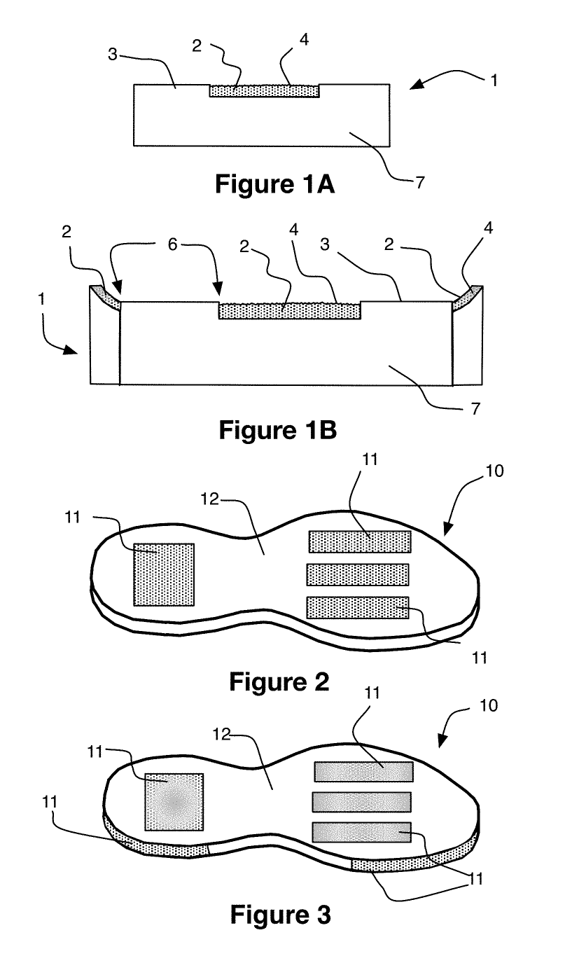

FIGS. 1A and 1B illustrate examples of hybrid moulds 1 for a shoe sole according to the invention. The body 7 of the mould comprises a moulding surface 3 and at least one moulding insert 2.

The moulding insert 2 is produced according to a method involving selective laser melting.

The moulding surface 3, and preferably the adjacent mass of material in which the moulding surface is readied, is produced according to a second method distinct from the first, for example by machining, stamping, etc.

As illustrated in the examples of FIGS. 1A and 1B, the insert is provided with textures 4. These textures are obtained for example by laser etching or by the addition of material.

FIGS. 2 and 3 are schematic perspective depictions of exemplary soles 10 that can be moulded using a hybrid mould as described hereinabove. The textures 11 generated by the mould in various specifically chosen zones on the sole can be seen. The soles comprise an alternation of textured zones 11 and of nontextured zones 12. This original configuration is down to the fact that the hybrid mould itself comprises a surface provided with an alternation of textured inserts 4 and untextured surfaces 3.

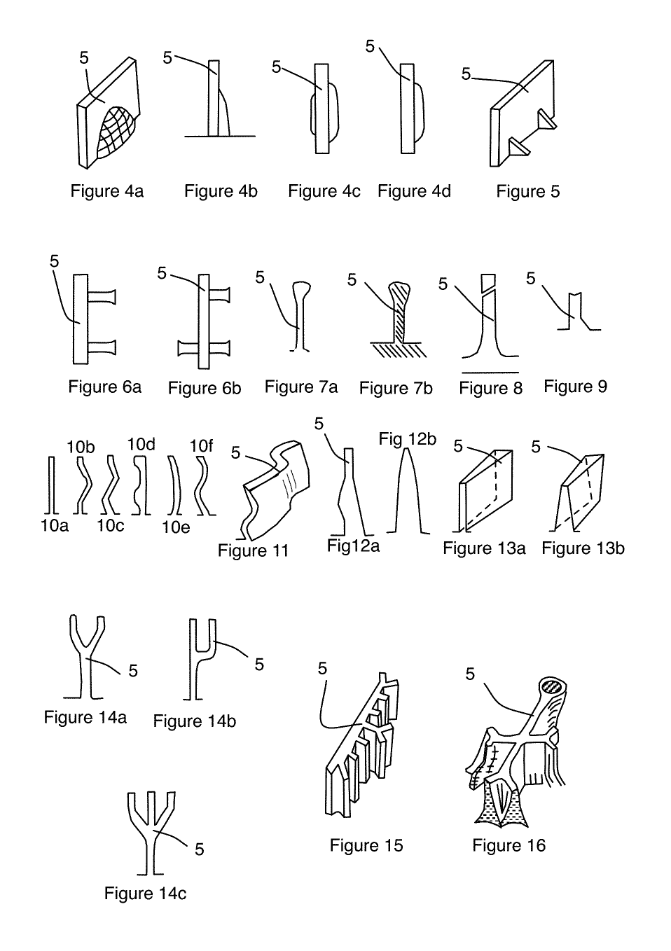

FIGS. 4a to 16 illustrate exemplary embodiments of insert portions provided with complex moulding shapes 5 for sole treads.

FIGS. 4a, 4b, 4c and 5 show examples of thin blades provided with a substantially rectangular main plane with a boss on one or two sides of the main plane. FIGS. 4a and 4b are elevations, whereas 4c and 4d are plan views. When two bosses are present, these may or may not be symmetrical. The cross section of the bosses may follow a determined profile, for example according to a mathematical law.

FIGS. 5, 6a and 6b show examples in which the substantially rectangular main plane is supplemented by a plurality of substantially perpendicular secondary planes, of appreciably smaller dimensions than the main plane. FIG. 5 is a side view whereas FIGS. 6a and 6b are plan views. The example of FIG. 6a has projections on one side and that of FIG. 6b has projections on both sides.

The examples in FIGS. 7a and 7b are side views in which the main plane is supplemented by a head the thickness of which is greater than that of the rest of the thin blade. FIGS. 8 and 9 illustrate examples in which the main planes are provided with junctions in order to avoid stress concentration zones.

FIG. 10a shows a side view of a straight (reference) main plane. FIGS. 10b to 10f illustrate examples of main planes of any non-straight (or non-planar) shapes, for example in the shape of an S, of a Z, of a curve, etc. FIG. 11 illustrates an exemplary embodiment in the shape of an elongated S. FIGS. 12a and 12b show examples, in side view, with thicknesses that vary along the vertical profile.

FIGS. 13a and 13b show examples in side view, with thicknesses varying along the longitudinal direction, in FIG. 13a, and along the longitudinal and vertical directions, in FIG. 13b.

FIGS. 14a and 14b illustrate an exemplary embodiment in the shape of an elongate Y. FIG. 14c illustrates an exemplary embodiment in the shape of an elongate fork.

FIGS. 15 and 16 illustrate examples of combinations of complex shapes selected for example from among the shapes already described and illustrated. FIG. 15 combines Y-shaped and rectilinear profiles. In FIG. 16, three Y-shaped profiles are mounted in opposition and supplemented by a rectilinear profile surmounted by an enlarged head.

All the foregoing examples (FIGS. 4a to 16) are advantageously produced using additive manufacturing.

### REFERENCE NUMERALS USED IN THE FIGURES

1 Hybrid mould
2 Insert
3 Moulding surface
4 Textures
5 Complex moulding shape for sole tread
6 Securing means
7 Mould body
10 Sole
11 Texture obtained after moulding
12 Untextured sole surface

1.-10. (canceled)

11. A hybrid mold for a shoe sole, the mold comprising:
a body affording a molding surface; and
at least one molding insert,
wherein the molding insert is produced according to a first method and the molding surface is produced according to a second method distinct from the first, and
wherein the molding insert is produced using a method of manufacture by addition of material.

12. The hybrid mold according to claim 11, wherein the material is a metallic material.

13. The hybrid mold according to claim 11, wherein the molding surface is produced according to a method not involving the addition of material.

14. The hybrid mold according to claim 11, wherein the insert comprises a plurality of textures.

15. The hybrid mold according to claim 14, wherein the plurality of textures of the insert are obtained by laser etching.

16. The hybrid mold according to claim 11, further comprising securing means for securing the insert to the body of the mold,
wherein the securing is accomplished by bonding, welding, clipping, screwing or clamping.

17. The hybrid mold according to claim 11, wherein the molding insert comprises a plurality of complex molding shapes for sole treads.

18. The hybrid mold according to claim 17, wherein at least one complex molding shape comprises a main plane that is not parallelepipedal.

19. The hybrid mold according to claim 17, wherein at least one complex molding shape comprises a main plane that has a bulging zone.

20. The hybrid mold according to claim 17, wherein at least one complex molding shape comprises a main plane in the shape of an elongated Y or S.

21. The hybrid mold according to claim 17, wherein at least one complex molding shape comprises a main plane and a plurality of secondary planes which are substantially perpendicular.
